(19) United States
(12) Patent Application Publication
(10) Pub. No.: US 2003/0214590 A1
(43) Pub. Date: Nov. 20, 2003

(54) System and method for adaptively compensating for dark current in an image capture device

(76) Inventor: Kevin Matherson, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/150,230

(22) Filed: May 17, 2002

(51) Int. Cl. H04N 9/64

(52) U.S. Cl. 348/243

(57) ABSTRACT

A system and related method for compensating for dark current in an image capture device is disclosed. An embodiment of the invention includes an image sensor for capturing a dark image, a memory element for storing the dark image, and logic for assigning a mathematical function to the dark image, where the only variable in the mathematical function is time. The image sensor captures an image, the image including a time of capture indicator, where the time of capture indicator is assigned to the mathematical function. The invention then calculates a dark current value at the time of image capture and subtracts the dark current value from the captured image.

### TECHNICAL FIELD

The present invention relates generally to digital photography, and, more particularly, to a system and method for adaptively compensating for dark current in an image-capture device using a charge-coupled device (CCD).

### BACKGROUND OF THE INVENTION

In many digital cameras, and digital still cameras in particular, the image-capture device is a charge-coupled device (CCD) element. Typically, a large number of these CCD elements are formed into a two-dimensional array comprising discrete light- sensing elements known as pixels. Each CCD element converts light, in the form of photons, into electrons that are subsequently stored in potential wells and eventually transferred to an output amplifier for detection. Various parameters and characteristics of the CCD element determine the amount of electrical charge that can be stored in the element. In essence, the CCD element can be viewed as a bucket for storing electrical charge.

Even in the absence of light, an energized CCD element will accumulate a charge that is proportional to the amount of time that the CCD element is energized. This signal can be referred to as a “dark count” or “dark current.” Dark current is unavoidable and results from random motion of electrons within the silicon used to fabricate the CCD element. Dark current exhibits a strong temperature dependence that changes logarithmically with temperature and is proportional to the CCD element area. At room temperature, the dark current doubles for approximately each eight (8) degrees Celsius (C) increase in temperature. The dark current of individual CCD elements may vary more or less than the average, depending on how the dark current was generated.

Dark current is also spatially non-uniform across the surface of the CCD element. However, because the defects that result in dark current are spatially fixed, the spatial distribution of dark current is time invariant. Dark current is stored in the CCD element as electrical noise that degrades the signal-to-noise ratio of the CCD element and results in an image that appears grainy.

FIG. 1 is a schematic diagram illustrating a CCD element 102 represented as a bucket for storing electrical energy. The amount of electrical energy that can be stored in the CCD element 102 is determined by the voltage applied to the CCD element (the voltage source and the terminals are omitted from FIG. 1 for simplicity). The CCD element 102 detects incoming photons (light energy), illustrated using reference numeral 104, and converts the photons into an electron-hole pair. For every photon having an energy level above the bandgap of the substrate material from which the CCD element 102 is formed, an electron is sent into the conduction band. This is illustrated by the photo-generated electrons 112 collecting at the bottom of the CCD element 102. In addition to the voltage applied to the CCD element 102, the amount of electrical energy that can be stored is also determined by the area defined by the X 114 and Y 116 dimensions of the CCD element.

In situations where no photons are present and the camera in which the CCD element 102 forms a part of an image capture array is operating, thermally-generated dark current continues to fill the CCD element 102 with thermal electrons 108. These thermal electrons 108 represent noise and continue to fill the CCD element 102 as the temperature of the CCD element 102 continues to increase. As mentioned above, the dark current is proportional to the temperature of the device, with the dark current doubling for approximately each eight (8) degree Celsius increase in temperature of the CCD element. Over time, the thermal electrons 108 fill the storage capacity of the CCD element 102 and reduce the sensitivity of the CCD element 102 by preventing further storage of photon generated electrons 112. Furthermore, the noise generated by the thermal electrons 108 degrades the signal-to-noise ratio capacity of the CCD element 102, and therefore, degrades the quality of any image captured by the CCD element 102.

One manner of reducing the number of thermal electrons 108, and therefore the dark current, is to reduce the temperature of the CCD element 102. Unfortunately, this solution is expensive and impractical in low-cost consumer electronic devices.

Another conventional manner for reducing the effect of dark current is to perform dark-frame subtraction. In this technique, for each image to be captured, a dark frame is captured with the shutter closed. The dark frame is converted to a numerical value and stored in memory, as is the captured dark frame image. Because the temperature will not have significantly changed between the time that the dark frame is captured and the time that the image frame is captured, the dark-frame value may be subtracted from the image value, thereby substantially eliminating the effect of the dark current. Unfortunately, because this technique requires the capture of two images for each image taken, it is memory intensive and therefore costly.

Therefore, there is a need in the industry for an efficient way of compensating for dark current in a CCD image capture element.

### SUMMARY OF THE INVENTION

Embodiments of the invention include a system and method for adaptively compensating for dark current in an image capture device by mapping the dark current of an image capture element over time, associating a mathematical function to the dark current, and subtracting the dark current from an image captured using the image capture device.

In one embodiment, the invention is an apparatus for compensating for dark current in an image-capture device. An embodiment of the invention includes an image sensor for capturing a dark image, a memory element for storing the dark image, and logic for assigning a mathematical function to the dark image, where the only variable in the mathematical function is time. The image sensor captures an image, the image including a time of capture indicator, where the time of capture indicator is assigned to the mathematical function. The invention then calculates a dark current value at the time of image capture and subtracts the dark current value from the captured image.

Related methods of operation and computer readable media are also provided. Other systems, methods, features, and advantages of the invention will be or become apparent to one with skill in the art upon examination of the following figures and detailed description. It is intended that all such additional systems, methods, features, and advantages be within the scope of the invention, and be protected by the accompanying claims.

### BRIEF DESCRIPTION OF THE DRAWINGS

Embodiments of the present invention, as defined in the claims, can be better understood with reference to the following drawings. The components within the drawings are not necessarily to scale relative to each other, emphasis instead being placed upon clearly illustrating the principles of the present invention.

FIG. 1 is a prior art schematic diagram illustrating a CCD pixel represented as a bucket for storing electrical energy.

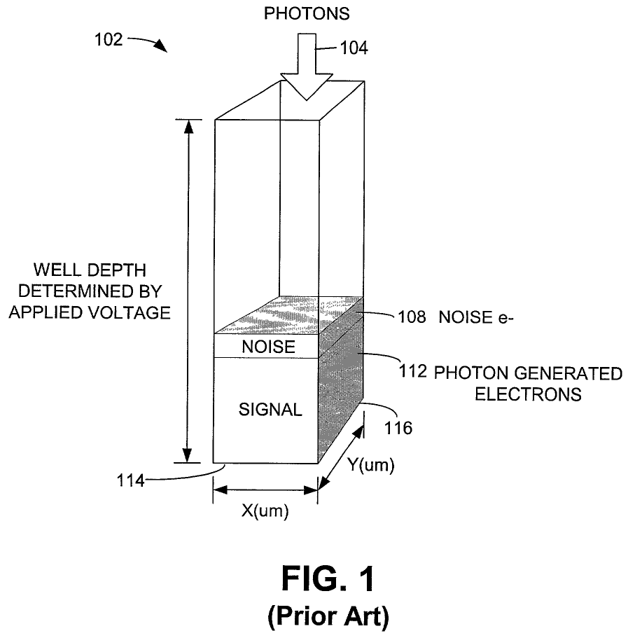

FIG. 2 is a block diagram illustrating a digital camera constructed in accordance with an embodiment of the invention.

FIG. 3 is a block diagram illustrating particular aspects of the application specific integrated circuit (ASIC) and the random access memory (RAM) of FIG. 2.

FIG. 4 is a flow chart illustrating a first portion of the dark current compensation method of the embodiment of the invention shown in FIG. 2.

FIG. 5 is a graphical illustration of the mathematical function assigned to an exemplar pixel.

FIG. 6 is a flow chart illustrating the dark current subtraction aspect of the embodiment of the invention shown in FIG. 2.

### DETAILED DESCRIPTION OF THE PREFERRED EMBODIMENT

The embodiments of the invention described below are applicable to any digital camera that uses a plurality of charge-coupled-device (CCD) elements arranged in an array to form an image-capture element.

The system and method for adaptively compensating for dark current can be implemented in hardware, software, firmware, or a combination thereof. In the preferred embodiment(s), the invention is implemented using a combination of hardware and software or firmware that is stored in a memory and that is executed by a suitable instruction execution system. The hardware portion of the invention can be implemented with any or a combination of the following technologies, which are all well known in the art: a discrete logic circuit(s) having logic gates for implementing logic functions upon data signals, an application-specific integrated circuit (ASIC) having appropriate combinational logic gates, a programmable gate array(s) (PGA), a field-programmable gate array (FPGA), etc. The software portion of the invention can be stored in one or more memory elements and executed by a suitable general purpose or application specific processor.

The program for adaptively compensating for dark current, which comprises an ordered listing of executable instructions for implementing logical functions, can be embodied in any computer-readable medium. In the context of this document, a “computer-readable medium” can be any means that can contain, store, communicate, propagate, or transport the program for use by or in connection with the instruction execution system.

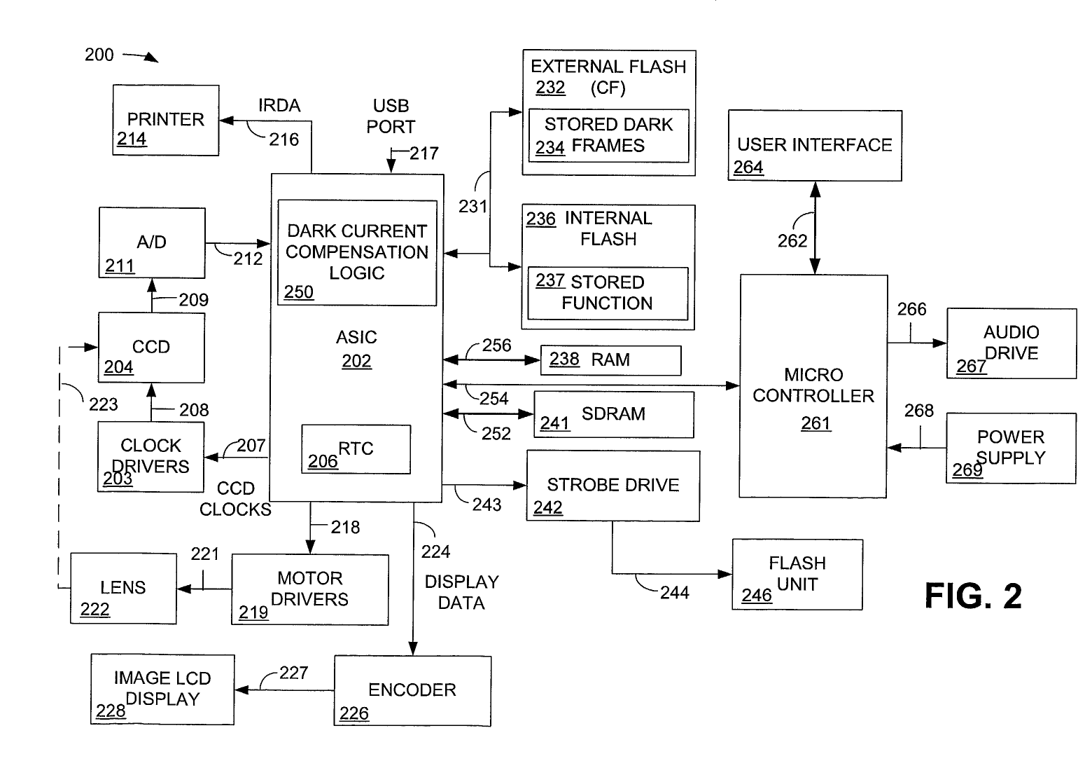

FIG. 2 is a block diagram illustrating a digital camera 200 constructed in accordance with an embodiment of the invention. In the implementation to be described below, the digital camera 200 includes an application-specific integrated circuit (ASIC) 202 that includes the dark current compensation logic 250 of the invention. In an alternative embodiment, the dark current compensation logic 250 may be implemented in software, which can be stored in a memory and executed by a suitable processor.

The ASIC 202 also includes, among other elements that are omitted for simplicity, a real time clock (RTC) 206, the operation of which will be described in further detail below. The ASIC 202 controls various functions of the digital camera 200. A CCD image-capture device 204 typically comprises a large number of individual CCD elements, each forming a picture element or pixel of a captured image. The CCD elements are typically arranged as an array or matrix. The CCD device or image array 204 captures an image of a subject (not shown) as a plurality of electrical charges in the CCD elements and sends this image via connection 209 to an analog-to-digital converter 211. The analog-to-digital converter 211 converts the analog signals received from the CCD elements 102 into digital signals and provides the digital signals as image data via connection 212 to the ASIC 202 for image processing.

The ASIC 202 also sends display data via connection 224 to an encoder 226. The encoder 226 converts the display data from the ASIC 202 into a signal that can be shown on image display 228 via connection 227. The image display 228, which can be, for example a liquid crystal display (LCD) or other display, displays the captured image to the user of a digital camera 200, and is typically the display located on the digital camera 200.

The ASIC 202 also supplies a strobe drive signal via connection 243 to the strobe drive element 242. The strobe drive element 242 activates the flash unit 246 via connection 244 when it is determined that flash photography is either necessary or desired.

The ASIC 202 may be coupled to a microcontroller 261 via connection 254. The microcontroller 261 controls the various functions of the digital camera 200. For example, the microcontroller 261 may be coupled to a user interface 264 via connection 262. The user interface 264 may include a keypad, one or more buttons, a mouse or pointing device, a shutter release, and any other buttons or switches that allow the user of the digital camera 200 to input commands.

The ASIC 202 also couples to one or more different memory elements, specific types of which are denoted below, but could be various other types of memory not specifically described herein. The memory elements may be either internal to the digital camera 200 or may be removable memory media, and may also comprise memory distributed over various elements within the digital camera 200. All such memory types are contemplated to be within the scope of the invention.

The ASIC 202 couples to static dynamic random access memory (SDRAM) 241 via connection 252. The SDRAM 241 houses the various software and firmware elements and components (not shown) that allow the digital camera 200 to perform its various functions. The ASIC 202 also couples to RAM 238 via connection 256. The RAM 238 generally provides temporary storage for the images (both normal images and the dark frame images) to be described below. The ASIC 202 also couples via connection 231 to an external flash memory 232 and an internal flash memory 236. As will be described in further detail below, the external flash memory 232, which can be, for example, compact flash memory, includes the stored dark frames 234, while the internal flash memory 236 includes a stored mathematical function 237. In accordance with an embodiment of the invention, the stored mathematical function 237 corresponds to and represent the profile of the dark current of the stored dark frames 234, and will be described in further detail below.

By implementing various embodiments of the invention, and by assigning a stored mathematical function 237 to the stored dark frames 234, the invention reduces the amount of memory required to perform dark-frame subtraction by not requiring that two images be captured each time the user of the digital camera 200 wishes to capture an image.

In accordance with an embodiment of the invention, one or more dark frames are taken and stored in external flash memory 232. The stored mathematical function 237, which is preferably a polynomial that has time as its only variable measured from the time at which the dark frame image is captured, is stored in the internal flash memory 236. When a dark frame image is captured by the digital camera 200, a time value taken from the real-time clock 206 is stored with the captured image and the time value is assigned to the stored function 237.

By assigning a real-time clock value to the stored mathematical function 237, the dark current existing at a later time when the image of a scene is captured may be readily calaculated and economically subtracted from the image of the scene. In this manner, a single stored dark frame image processed by the stored mathematical function 237 may be used in place of a separate dark frame image associated with each captured image of a scene.

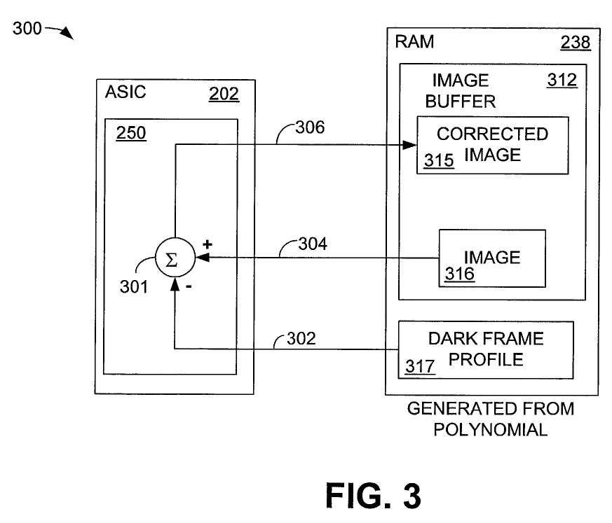

FIG. 3 is a block diagram 300 illustrating particular aspects of the ASIC 202 and the RAM 238 of FIG. 2. The ASIC 202 includes the dark current compensation logic 250, which includes, among other elements, an adder 301. The RAM 238 includes an image buffer 312 and a dark-frame profile value 317. The dark-frame profile value 317 represents the dark current at time t (the time that the desired image is taken). The image buffer 312 stores a desired image 316 and a corrected image 315. When the desired image 316 is captured, the adder 301 subtracts the dark-frame profile value 317 from the desired image 316 and supplies the corrected image 315 via connection 306. The corrected image 315 represents the desired image 316 having the dark current subtracted therefrom.

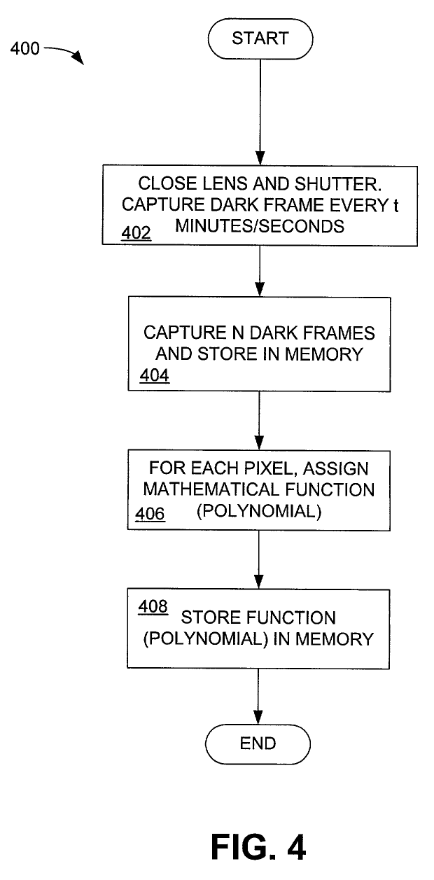

FIG. 4 is a flow chart 400 illustrating a first portion of the dark current compensation method of the invention. In block 402 the lens 222 is closed or covered, the shutter is closed, and the digital camera 200 captures a dark frame every t minutes or seconds. The number of dark frames that are captured and the spacing between the dark frames are determined by the quality of the CCD element 204, and other parameters. Dark current is randomly generated and can be described by Poisson statistics. By capturing a dark frame more often, and for a longer period of time, a better estimate of the dark frame can be obtained. Unfortunately, capturing a longer dark frame results in a longer shot-to-shot time and should be balanced against the time available for acquiring a dark frame having a sufficient quantity of captured electrons to minimize uncertainty.

In block 404 as each dark frame is captured, the ASIC 202 transfers the dark frame temporarily to the RAM 238 (FIG. 2). The ASIC 202 then compresses the dark frame (not shown in detail because image compression is known to those having ordinary skill in the art) and then transfers each dark frame to the external flash memory 232 (FIG. 2). Each dark frame is stored in the external flash 232, with the plurality of dark frames being represented as the stored dark frames element 234 (FIG. 2).

Next, in block 406, and for each pixel in the array, a mathematical function is assigned to each pixel in which the only variable in the mathematical function is time (i.e., the time at which the desired image will be captured). The mathematical function may be a polynomial or a function that describes the surface formed by the array of pixels in the CCD element.

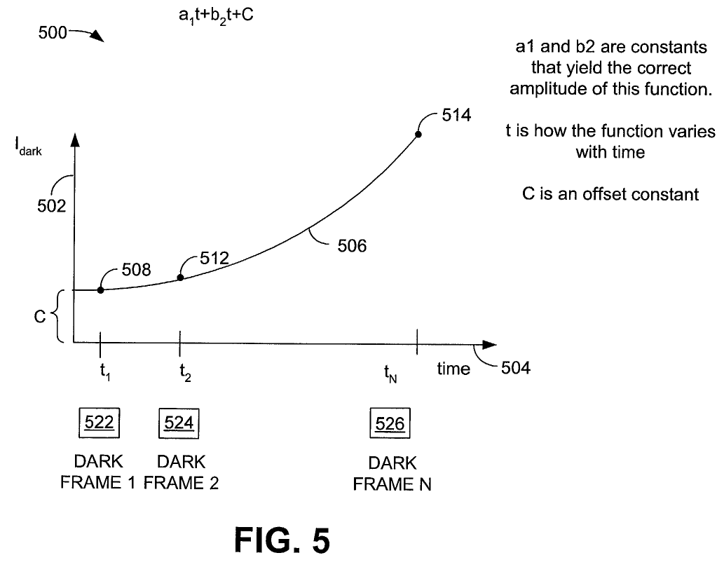

For example, a polynomial can be fit to an individual pixel or a surface equation can be fit to the two-dimensional array of CCD elements. When the point in time that the desired image is captured is entered into the polynomial function, the polynomial function represents the dark current profile for each of the dark frames that were captured over time t. This is illustrated below with respect to FIG. 5.

To simplify the operation of this aspect of the invention, the external flash memory element 232 may be removed and transferred to another computer to perform this step of fitting the mathematical function to the dark frames. The other computer can be any general purpose or specific purpose computer, and can be, for example but not limited to, a personal computer.

FIG. 5 is a graphical illustration 500 of the mathematical function assigned to an exemplar pixel. In the graphical illustration 500, the vertical axis 502 represents the dark current, I_{dark}, while the horizontal axis 504 represents time, t. In the example shown in FIG. 5, a first dark frame 522 is captured at time t_{N}, a second dark frame 524 is captured at time t₂, and an Nth dark frame 526 is captured at t_{N}. The curve 506 represents the dark current captured by the exemplar pixel over time t. The point 508 represents the dark current at time t₁, the point 512 represents the dark current at time t₂ and the point 514 represents the dark current at the time t_{N}. In this example, and for the dark frames illustrated, the polynomial function a₁t+b₂t+C, represents all the dark frames taken for the exemplar pixel shown in the illustration 500. The terms a₁ and b₂ are constants that yield the correct amplitude of this function at each given time, t. The term t describes the variation of the function over time, and C is an offset constant. As shown in FIG. 5, in the polynomial a₁t+b₂t+C the only variable is time, t. This time, t, is the time (in the future) at which the desired image will be captured by a user of the digital camera 200.

Referring back to FIG. 4, in block 408, the polynomial a₁t+b₂t+C is stored in the internal flash memory 236 (FIG. 2) as the stored function 237 (FIG. 2). When solved over time, this polynomial represents the dark frame profile of the exemplar pixel 500 of the dark frames taken over time.

The following is an exemplar code portion that can be used to fit the polynomial a₁t+b₂t+C to a surface comprising a plurality of pixels in the CCD element 204 (FIG. 2). One having ordinary skill in the art will understand the application of this code segment to the pixels that comprise a CCD array.

function P=surf3_fit(f);
global X Y
[M,N,C]=size(f);
x=[1:N];
y=[1:M];
[X,Y]=meshgrid(x,y);
for i=1:7

for j=1:7

XY=(X.\hat{ }(i−1)).*(Y.\hat{ }(j−1));
xy(i,j)=sum(sum(XY));

end

end
M=[

xy(7,1) xy(6,2) xy(5,3) xy(4,4) xy(6,1) xy(5,2) xy(4,3) xy(5,1) xy(4,2) xy(4,1)
xy(6,2) xy(5,3) xy(4,4) xy(3,5) xy(5,2) xy(4,3) xy(3,4) xy(4,2) xy(3,3) xy(3,2)
xy(5,3) xy(4,4) xy(3,5) xy(2,6) xy(4,3) xy(3,4) xy(2,5) xy(3,3) xy(2,4) xy(2,3)
xy(4,4) xy(3,5) xy(2,6) xy(1,7) xy(3,4) xy(2,5) xy(1,6) xy(2,4) xy(1,5) xy(1,4)
xy(6,1) xy(5,2) xy(4,3) xy(3,4) xy(5,1) xy(4,2) xy(3,3) xy(4,1) xy(3,2) xy(3,1)
xy(5,2) xy(4,3) xy(3,4) xy(2,5) xy(4,2) xy(3,3) xy(2,4) xy(3,2) xy(2,3) xy(2,2)
xy(4,3) xy(3,4) xy(2,5) xy(1,6) xy(3,3) xy(2,4) xy(1,5) xy(2,3) xy(1,4) xy(1,3)
xy(5,1) xy(4,2) xy(3,3) xy(2,4) xy(4,1) xy(3,2) xy(2,3) xy(3,1) xy(2,2) xy(2,1)
xy(4,2) xy(3,3) xy(2,4) xy(1,5) xy(3,2) xy(2,3) xy(1,4) xy(2,2) xy(1,3) xy(1,2)
xy(4,1) xy(3,2) xy(2,3) xy(1,4) xy(3,1) xy(2,2) xy(1,3) xy(2,1) xy(1,2) xy(1,1)

]
P=[];
v=zeros(10,1);
for c=1:C

fc=f(:,:,c);
v(1)=sum(sum(XYZ(4,1).*fc));
v(2)=sum(sum(XYZ(3,2).*fc));
v(3)=sum(sum(XYZ(2,3).*fc));
v(4)=sum(sum(XYZ(1,4).*fc));
v(5)=sum(sum(XYZ(3,1).*fc));
v(6)=sum(sum(XYZ(2,2).*fc));
v(7)=sum(sum(XYZ(1,3).*fc));
v(8)=sum(sum(XYZ(2,1).*fc));
v(9)=sum(sum(XYZ(1,2).*fc));
v(10)=sum(sum(XYZ(1,1).*fc));
P=[P M\v];

end
function out=XYZ(i,j)
global X Y
out=(X.\hat{ }(i−1)).*(Y.\hat{ }(j−1));

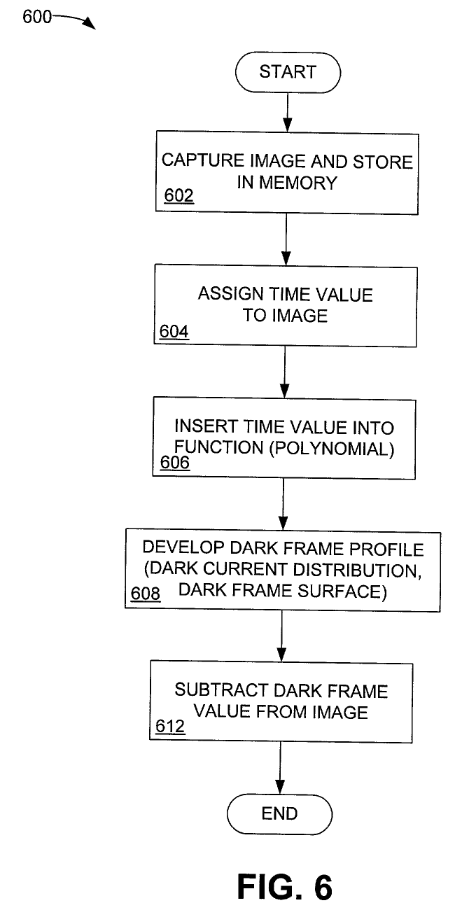

FIG. 6 is a flow chart 600 illustrating the dark current subtraction aspect of the invention. In block 602, a user of the digital camera 200 captures a desired image using the CCD array 204. The ASIC 200 stores this image in RAM 238 as image 316 (FIG. 3). As mentioned above, the real time clock 206 (FIG. 2) located in the ASIC 202 includes information relating to the time at which the image 316 was captured. In block 604, the dark current compensation logic 250 extracts the real time clock value from the real time clock 206 and assigns a time value to the image 316.

In block 606, the dark current compensation logic 250 inserts the time value into the mathematical function 237 (i.e., into the polynomial) stored in the internal flash memory 236 (FIG. 2). By inserting the time, t, into the mathematical function 237, a complete representation of the dark current is computed using the stored mathematical function 237 (i.e., the polynomial). In block 608, the dark current compensation logic 250 develops a dark frame profile value 317 (FIG. 3) that represents the dark current distribution over the surface of the CCD array at the time (the t term in the mathematical function of (FIG. 5)) that the desired image was captured. In this manner, the dark current compensation logic 250 now has information relating to the dark current contribution to the image 316 taken at time t. In block 612, the dark frame profile value 317 is subtracted from the image 316 using the adder 301, resulting in a corrected image 315 (FIG. 3). In this manner, the dark current of the CCD elements of CCD array 204 at the time the desired image was captured can be removed from the desired image without the necessity of capturing two images for each desired image, thus significantly reducing the amount of memory required to perform dark current compensation.

While various embodiments of the invention have been described, it will be apparent to those of ordinary skill in the art that many more embodiments and implementations are possible that are within the scope of this invention. All such modifications and variations are intended to be included herein within the scope of this disclosure and the present invention and protected by the following claims.

What is claimed is:

1. A system for compensating for dark current in an image-capture device, comprising:
an image sensor for capturing a dark image;
a memory element for storing the dark image;
logic for assigning a mathematical function to the dark image, where the only variable in the mathematical function is time, the mathematical function stored in the memory;
where the image sensor captures an image, the image including a time of capture indicator and where the time of capture indicator is assigned to the mathematical function, and where the logic calculates a dark current value at the time of image capture; and
where the logic subtracts the dark current value from the captured image.

2. The system of claim 0, wherein the image sensor is a charge-coupled device (CCD).

3. The system of claim 0, wherein the mathematical function is a polynomial.

4. The system of claim Error! Bookmark not defined., wherein the polynomial is stored in a compact flash memory.

5. The system of claim Error! Bookmark not defined., wherein the polynomial represents the dark current of each of a plurality of pixels in the image sensor.

6. The system of claim 0, further comprising an application-specific integrated circuit (ASIC) that stores the logic for assigning a mathematical function to the dark image and the time of capture indicator.

7. The system of claim Error! Bookmark not defined., wherein the time of capture indicator is a real-time clock associated with the ASIC.

8. A method for compensating for dark current in an image-capture device, the method comprising the steps of:
capturing a dark image using an image sensor;
assigning a mathematical function to the dark image, where the only variable in the mathematical function is time;
storing the mathematical function in a memory;
capturing an image using the image sensor;
recording the time of image capture;
assigning the time of image capture to the mathematical function;
calculating a dark current value at the time of image capture; and
subtracting the dark current value from the captured image.

9. The method of claim Error! Bookmark not defined, wherein the image-capture device is a charge-coupled device (CCD).

10. The method of claim Error! Bookmark not defined, wherein the mathematical function is a polynomial.

11. The method of claim Error! Bookmark not defied, further comprising the step of storing the polynomial in a compact flash memory.

12. The method of claim Error! Bookmark not defined, wherein the polynomial represents the dark current of each of a plurality of pixels in the image sensor.

13. A computer-readable medium having a program for compensating for dark current in an image-capture device, the program including logic for performing the steps of:
capturing a dark image using an image sensor;
assigning a mathematical function to the dark image, where the only variable in the mathematical function is time;
storing the mathematical function in a memory;
capturing an image using the image sensor;
recording the time of image capture;
assigning the time of image capture to the mathematical function;
calculating a dark current value at the time of image capture; and
subtracting the dark current value from the captured image.

14. The program of claim Error! Bookmark not defined, wherein the image capture device is a charge coupled device (CCD).

15. The program of claim Error! Bookmark not defined, wherein the mathematical function is a polynomial.

16. The program of claim Error! Bookmark not defined, further comprising the step of storing the polynomial in a compact flash memory.

17. The program of claim Error! Bookmark not defined, wherein the polynomial represents the dark current of each of a plurality of pixels in the image sensor.
